(19) United States
(12) Patent Application Publication
(10) Pub. No.: US 2026/0342403 A1
(43) Pub. Date: Oct. 29, 2026

(54) AI-BASED CHANNEL STATE INFORMATION FEEDBACK WITH SIDE INFORMATION

(71) Applicant: Samsung Electronics Co., Ltd., Suwon-si (KR)

(72) Inventors: Xiaochuan Ma, Hillsborough, NJ (US); William Xia, Ozone Park, NY (US); Yan Xin, Princeton, NJ (US); Jianzhong Zhang, Dallas, TX (US)

(21) Appl. No.: 19/643,643

(22) Filed: Apr. 9, 2026

Related U.S. Application Data
(60) Provisional application No. 63/795,159, filed on Apr. 25, 2025.

(51) Int. Cl. H04B 7/06; H04L 5/00; H04L 25/02

(52) U.S. Cl. CPC H04B 7/0626; H04L 5/0044; H04L 25/0202

(57) ABSTRACT

Apparatuses and methods for operating a base station (BS) are provided. In one embodiment, a method for operating a BS is provided. The method includes determining at least one correlation between an uplink (UL) channel state information (CSI) data and downlink (DL) CSI data using a deep learning-based CSI up-sampling model, and determining resource block-level (RB-level) DL CSI information using the deep learning-based CSI up-sampling model based on the correlation between the UL CSI data and the DL CSI data.

### CROSS-REFERENCE TO RELATED APPLICATION AND CLAIM OF PRIORITY

This application claims priority under 35 U.S.C. § 119 (e) to U.S. Provisional Patent Application No. 63/795,159 filed on Apr. 25, 2025. The above-identified provisional patent application is hereby incorporated by reference in its entirety.

### TECHNICAL FIELD

This disclosure relates generally to multiple input multiple output (MIMO) systems. More specifically, this disclosure relates to apparatuses and methods learning the physical environment information for efficient downlink data transmission in MIMO systems.

### BACKGROUND

To fully leverage the advantages of MIMO technology, acquiring accurate Channel State Information (CSI) is essential for designing precoders that maximize downlink (DL) channel gain. Unlike time-division duplexing (TDD) systems, channel reciprocity does not apply between uplink (UL) and DL CSIs in frequency-division duplexing (FDD) systems. Therefore, FDD systems rely on either implicit or explicit DL CSI feedback from users. As operating frequencies increase, new cellular systems utilize massive MIMO technology to achieve higher energy and spectrum efficiency. However, the increased number of antennas significantly raises the feedback overhead. To reduce this overhead, current 5G cellular networks employ implicit CSI feedback per subband (SB) instead of per resource block (RB) for UL feedback, which unfortunately leads to severe precoder gain degradation under channels with frequency-selective fading. Recently, deep learning-based CSI feedback has garnered significant attention. Studies have verified that its feedback efficiency surpasses standardized approaches such as new radio (NR) type I and type II, as well as other compressive-sensing-based solutions.

### SUMMARY

This disclosure provides apparatuses and methods for AI-based CSI feedback enhancement with side information.

In one embodiment, a method for operating a base station (BS) is provided. The method includes determining at least one correlation between an uplink (UL) channel state information (CSI) data and downlink (DL) CSI data using a deep learning-based CSI up-sampling model, and determining resource block-level (RB-level) DL CSI information using the deep learning-based CSI up-sampling model based on the correlation between the UL CSI data and the DL CSI data.

In another embodiment a BS is provided. The BS includes at least one processor including processing circuitry, and a memory storing instructions. The instructions, when executed by the at least one processor, individually or collectively, cause the BS to determine at least one correlation between an UL CSI data and DL CSI data using a deep learning-based CSI up-sampling model, and determine RB-level DL CSI information using the deep learning-based CSI up-sampling model based on the correlation between the UL CSI data and the DL CSI data.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2A illustrates an example BS according to embodiments of the present disclosure;

FIG. 2B illustrates an example server 250, according to embodiments of the present disclosure;

FIG. 3 illustrates an example of a UE according to embodiments of the present disclosure;

FIG. 4 illustrates an example graph that illustrates an example of signal recovery according to embodiments of the present disclosure;

FIG. 5 illustrates an example procedure of multi-path component reciprocity according to embodiments of the present disclosure;

FIG. 6 illustrates an example procedure for precoder feedback according to one or more embodiments of the present disclosure;

FIG. 7 illustrates an example procedure for precoder up-sampling in a cellular network according to one or more embodiments of the present disclosure;

FIG. 8 illustrates an example flowchart of an example method for deep learning-based CSI up-sampling according to one or more embodiments of the present disclosure;

FIG. 9 illustrates a flowchart of example method for preprocessing CSI data according to embodiments of the present disclosure;

FIG. 10 illustrates a flowchart of example method of CSI up-sampling using a deep learning-based CSI up-sampling model according to embodiments of the present disclosure;

FIG. 11 illustrates an architecture including an example deep learning-based CSI up-sampling model according to embodiments of the present disclosure;

FIG. 12 illustrates an example encoder/decoder according to embodiments of the disclosure;

FIG. 13 illustrates an example simple gate used in a NAFNet block according to embodiments of the present disclosure;

FIG. 14 illustrates an example NAFNet block according to embodiments of the present disclosure;

FIG. 15 illustrates an example channel attention module according to embodiments of the present disclosure;

FIG. 16 illustrates an example architecture including a deep learning-based CSI up-sampling model that utilizes multi-stage fusion according to embodiments or the present disclosure; and

FIG. 17 illustrates a flowchart of an example method 1700 for determining RB-level DL CSI information using a deep learning-based CSI up-sampling model according to embodiments of the present disclosure.

### DETAILED DESCRIPTION

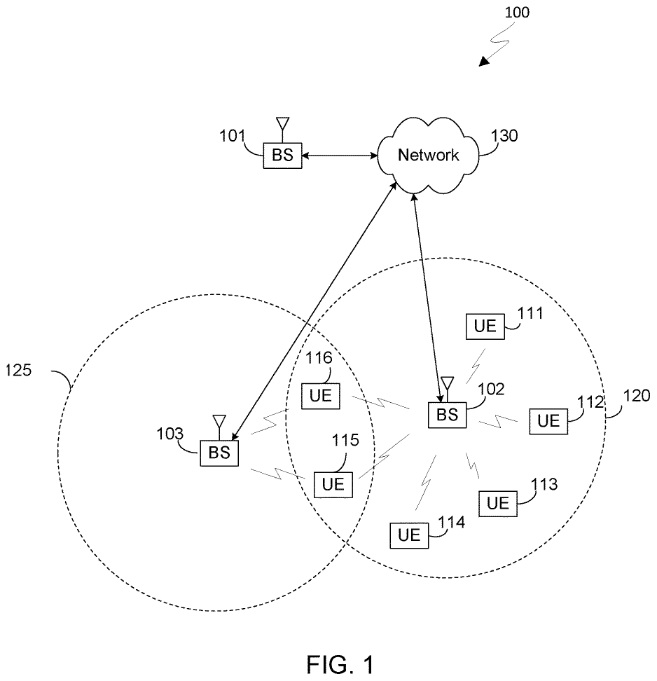

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To fully leverage the advantages of multiple input multiple output (MIMO) technology, acquiring accurate Channel State Information (CSI) is essential for designing precoders that maximize downlink (DL) channel gain. Unlike time-division duplexing (TDD) systems, channel reciprocity does not apply between uplink (UL) and DL CSIs in frequency-division duplexing (FDD) systems. Therefore, FDD systems rely on either implicit or explicit DL CSI feedback from users. As operating frequencies increase, new cellular systems utilize massive MIMO technology to achieve higher energy and spectrum efficiency. However, the increased number of antennas significantly raises the feedback overhead. To reduce this overhead, current 5G cellular networks employ implicit CSI feedback per subband (SB) instead of per resource block (RB) for UL feedback, which unfortunately leads to severe precoder gain degradation under channels with frequency-selective fading. Recently, deep learning-based CSI feedback has garnered significant attention. Studies have verified that its feedback efficiency surpasses standardized approaches such as new radio (NR) type I and type II, as well as other compressive-sensing-based solutions.

Machine (deep) learning-based channel estimation methods hold the potential to make wireless communication systems more adaptive, efficient, and robust, particularly in challenging environments. As the field of machine learning continues to advance, these methods are expected to play an increasingly important role in optimizing wireless communication systems for a wide range of applications, including 5G, IoT, and beyond. By removing or replacing the nonlinear activation functions (e.g. Sigmoid, ReLU, and GELU) and applying a simple network architecture, Nonlinear Activation Free Network (NAFNet) has shown great promise as it achieved state of the art (SOTA) image restoration performance and low complexity at the same time. For example, NAFNet achieved 33.69 dB PSNR on GoPro (for image deblurring), exceeding the previous SOTA 0.38 dB with only 8.4% of its computational costs. It also achieved 40.30 dB PSNR on SIDD (for image denoising), exceeding the previous SOTA 0.28 dB with less than half of its computational costs. Considering the similarity of the image restoration problem and the channel estimation problem, NAFNet has great promise in CSI up-sampling.

In FDD cellular networks, user terminals estimate DL CSI according to reference signals (CSI-RS), calculate the optimal/suboptimal precoder and feed back to base stations (BSs) for enhancing DL spectrum efficiency. With the increasing operating frequency in modern communications systems, the size of feedback overhead significantly increases accordingly. Due to the limited air resources, user terminals are not allowed to feedback full-resolution precoders to BSs. Instead, they feedback precoders in a subband-level (SB-level) instead of resource block level (RB-level) resolution. This may lead to severe performance degradation in terms of DL channel gain under channels with large delay spread (such as common outdoor channels). Thus, operators aim to design a non-linear mapping function at BSs from subband-level precoders to RB-level ones. However, the down sampling from RB-level to SB-level precoder sometimes causes the aliasing phenomenon which is theoretically irretrievable. It is not possible to find a perfect mapping from RB-level to SB-level precoders.

However, the issue is how to exploit UL CSI information for precoder up-sampling. For example, an arbitrary signal X∈ [symbol] ^{N} in frequency domain and its down-sampled signal

$${X}_{D S} = X [ 0 \text{::} D ] ∈ {ℂ}^{\frac{N}{D}} ,$$

given the discrete fourier transform (DFT) shifting property, after the inverse DFT (IDFT) transformation, the two signals in delay domain have the following relationship:

$${x}_{D S} [ n ] = \frac{( x [ n ] + x [ n + \frac{N}{D} ] + x [ n + \frac{2 N}{D} ] + … )}{D}$$

If x[n]≠0 for any n≥N/D, aliasing effect occurs after down-sampling and it cannot be recovered to the original version in general cases. However, x[n] can be perfectly recovered if x[n] satisfies the bin isolation property and has knowledge of the delays in the original signal. The bin isolation property means that only one of x[n]+x[n+N/D]+x[n+2N/D]+ . . . is non-zero. Namely, the wrapped-around bins and low-delay bin do not collide with each other. In this case, the original signal can be mapped by extracting the value in x_{DS}[n] if the delay of each bin is perfectly known.

This disclosure relates to AI-based (deep learning-based) CSI feedback enhancement with side information, including conducting precoder up-sampling by leveraging UL CSI to deal with aliasing effects. Furthermore, this disclosure relates to methods to find a mapping function at BS from RB-level precoder to SB-level precoder by introducing deep learning to properly leverage the instantaneous UL CSIs. Due to multipath component reciprocity (i.e., paths with similar directions and delays shown in FIG. 5 below), the instantaneous UL CSIs is utilized to estimate the RB-level CSI information (data). User terminals only need to feed back down-sampled RB-level precoders to BS and do not have extra processing. Then, the BS recovers the high-quality RB-level precoder based the framework disclosed herein with the side information to deal with aliasing effects.

Some embodiments described herein assume the CSI up-sampling task in FDD cellular systems. However, the same/similar principles and related signaling methods & configurations can also be used for any other signal up-sampling problem.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a base station (BS) 101 a BS 102, and a BS 103. The BS 101 communicates with the BS 102 and the BS 103. The BS 101 also communicates with at least one network 130, such as the Internet, a proprietary Internet Protocol (IP) network, or another data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB) a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the BSs and/or one or more of the UEs 111-116 include a framework for AI-based Channel State Information (CSI) feedback enhancement with side information.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

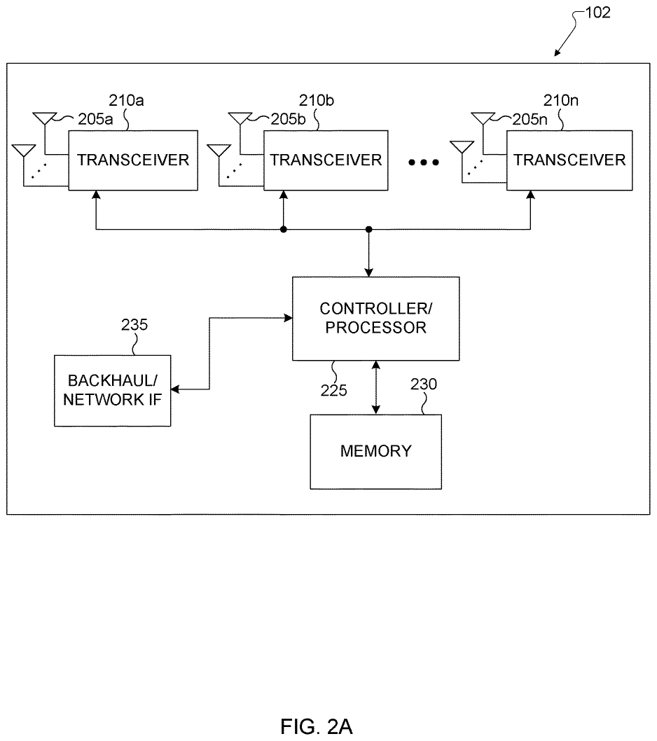

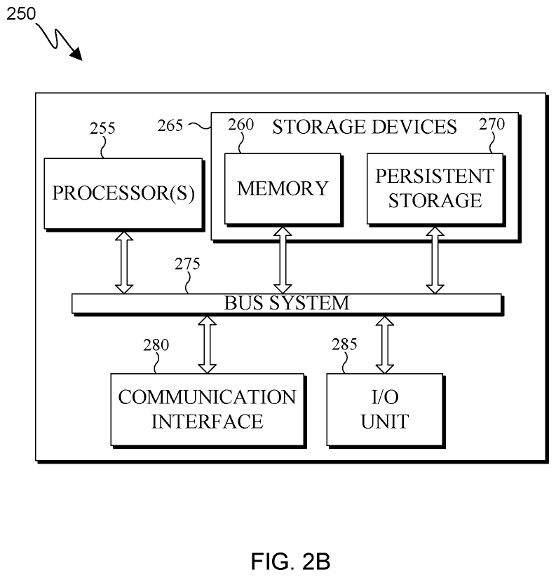

FIG. 2A illustrates an example BS 102 according to embodiments of the present disclosure. The embodiment of the BS 102 illustrated in FIG. 2A is for illustration only, and the BSs 101 and 103 of FIG. 1 could have the same or similar configuration. However, BSs come in a wide variety of configurations, and FIG. 2A does not limit the scope of this disclosure to any particular implementation of a BS.

As shown in FIG. 2A, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as processes for a framework for AI-based CSI feedback enhancement with side information as described in greater detail below. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2A illustrates one example of BS 102, various changes may be made to FIG. 2A. For example, the BS 102 could include any number of each component shown in FIG. 2A. Also, various components in FIG. 2A could be combined, further subdivided, or omitted and additional components could be added according to particular needs.

FIG. 2B illustrates an example server 250, according to embodiments of the present disclosure. The server 250 can represent one or more encoders, decoders, local servers, remote servers, clustered computers, and components that act as a single pool of seamless resources, a cloud-based server, and the like. The server 250 can be accessed by one or more of the UEs 111-115 and/or the BS 102 of FIG. 1 or another server.

As shown in FIG. 2B, the server 250 can represent one or more local servers, one or more compression servers, or one or more encoding servers, such as an encoder. In certain embodiments, the encoder can perform decoding. As shown in FIG. 2B, the server 250 includes a bus system 275 that supports communication between at least one processing device (such as a processor 255), at least one storage device 265, at least one communications interface 280, and at least one input/output (I/O) unit 285.

The processor 255 executes instructions that can be stored in a memory 260. The processor 255 can include any suitable number(s) and type(s) of processors or other devices in any suitable arrangement. Example types of processors 255 include microprocessors, microcontrollers, digital signal processors, field programmable gate arrays, application specific integrated circuits, and discrete circuitry.

The memory 260 and a persistent storage 235 are examples of storage devices 265 that represent any structure(s) capable of storing and facilitating retrieval of information (such as data, program code, or other suitable information on a temporary or permanent basis). The memory 260 can represent a random access memory or any other suitable volatile or non-volatile storage device(s). For example, the instructions stored in the memory 260 can include instructions for AI-based CSI feedback enhancement with side information. The persistent storage 270 can contain one or more components or devices supporting longer-term storage of data, such as a read only memory, hard drive, Flash memory, or optical disc.

The communications interface 280 supports communications with other systems or devices. For example, the communications interface 280 could include a network interface card or a wireless transceiver facilitating communications over the network 102 of FIG. 1. The communications interface 280 can support communications through any suitable physical or wireless communication link(s).

The I/O unit 285 allows for input and output of data. For example, the I/O unit 285 can provide a connection for user input through a keyboard, mouse, keypad, touchscreen, or other suitable input device. The I/O unit 285 can also send output to a display, printer, or other suitable output device. Note, however, that the I/O unit 285 can be omitted, such as when I/O interactions with the server 250 occur via a network connection.

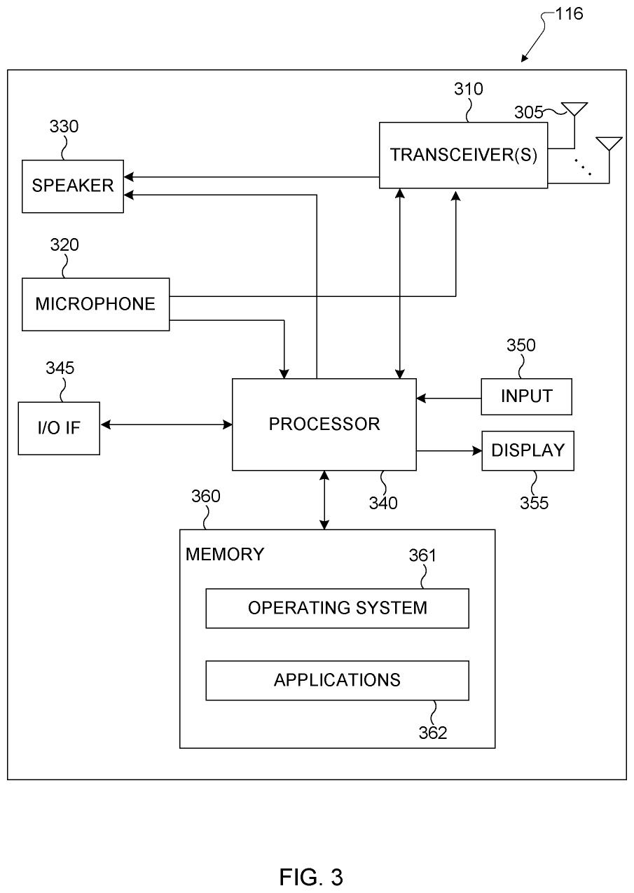

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. For example, in various embodiments, the UE 116 uses a framework AI-based CSI feedback enhancement with side information.

In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

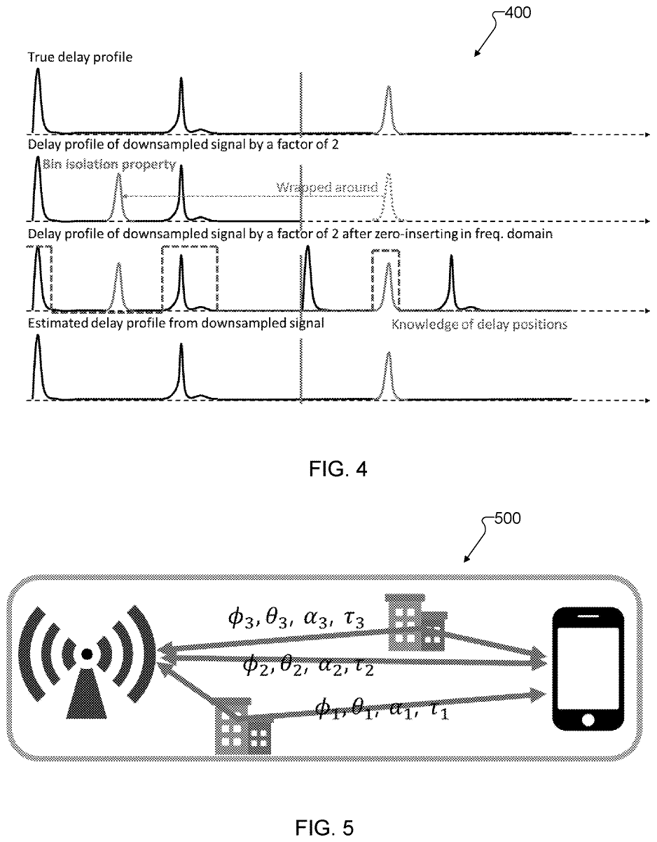

FIG. 4 illustrates an example graph 400 that illustrates an example of signal recovery, according to embodiments of the present disclosure. FIG. 5 illustrates an example procedure 500 of multi-path component reciprocity according to embodiments of the present disclosure

For example, and as illustrated in FIG. 4, a signal is down-sampled by a factor of two, and exact knowledge of the delay profile is known. In one or more embodiments, this delay information is impossible to have without the original signal X. However, in communications systems, the original signal X, which is DL CSI, is highly correlated to UL CSI, which is locally available at the BS, in terms of magnitudes in delay and angle domains. Although DL and UL CSIs are not correlated in FDD wireless system, as illustrated in FIG. 5, their large-scale multipath geometries are identical, leading to similar delay and angle profiles. Although there is no knowledge of the delay profile of DL CSI, a good estimate from evaluating the delay profile of UL CSI can be accessed. If no aliasing effect in UL CSI is ensured, then a design a bandpass filter can be designed in the delay and angle domain to suppress the aliasing effects. In modern communications systems, the reference signal density in frequency domain for UL CSI estimation is much higher than the pilot density for DL CSI. Thus, no aliasing effect occurs in UL CSI. This disclosure provides to conduct precoder up-sampling by leveraging UL CSI to deal with aliasing effects. Given the SB-level DL CSI matrix H_{SB}∈ [symbol] ^{N}^{ₐ}_{×N} (also referred to herein as “DL CSI-RS matrix”) and RB-level UL CSI matrix H_{RB·UL}∈ [symbol] ^{N}^{ₐ}^{×N}^{_{RB}}, this disclosure aims to get a estimation of the RB-level DL CSI matrix H_{RB}∈ [symbol] ^{N}^{ₐ}^{×N}^{_{RB}}, where Nₐ, N and N_{RB} are the numbers of antennas, SBs and the RBs, respectively.

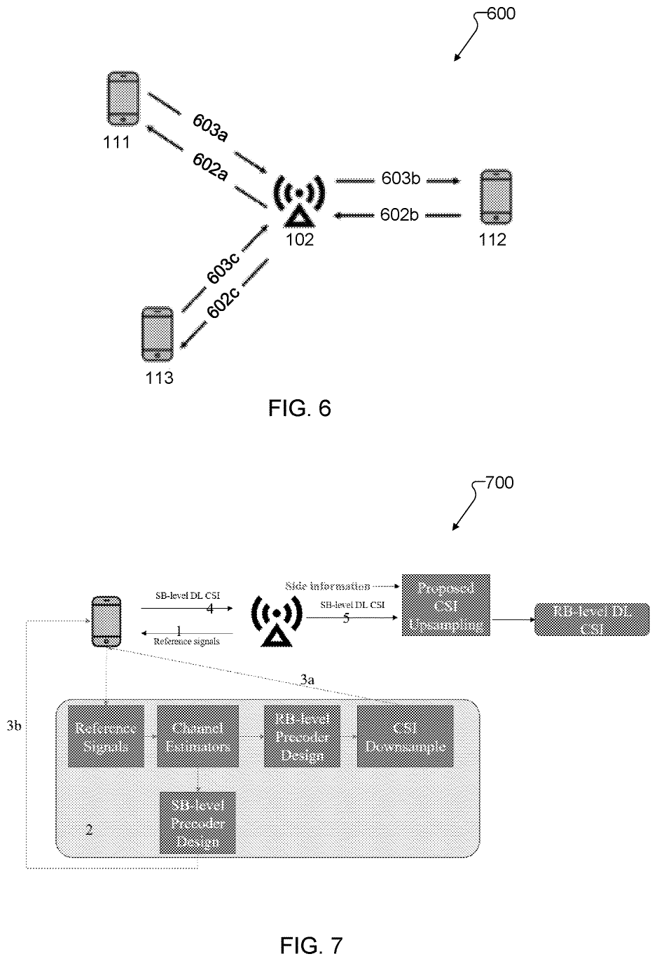

FIG. 6 illustrates an example procedure 600 for precoder feedback according to one or more embodiments of the present disclosure. FIG. 7 illustrates an example procedure 700 for precoder up-sampling in a cellular network according to one or more embodiments of the present disclosure.

Referring to FIG. 6, the BS 102 sends an RB-level RS (such as a DL CSI-RS) via the interface 602a, 602b, 602c to multiple UEs, including, but not limited to UEs 111-113. Then, the UEs 111-113 calculate the optimal RB-level precoder according the estimated channels obtained from the RSs and feedback to the BS 102 via the interface 603a, 603b, and 603c.

In one or more embodiments, as illustrated in FIG. 7, in order to reduce uplink feedback overhead, user terminals (UEs) can either down-sample RB-level precoder(s) (3a) or calculate SB-level precoder(s) (3b) and send it back to the BS 102. However, these are generally harmful to the acquisition of full channel gain under channels with large delay spread (i.e., large channel variation in frequency domain). Therefore, various solution disclosed herein can recover RB-level precoder(s) (matrices) from SB-level precoder(s) (matrices) so that can not only reduce the uplink feedback overhead but also maintain the channel gain obtained from RB-level precoder(s).

In one or more embodiments, as will be described in more detail below, the deep learning-based up-sampling model described herein can achieve superior CSI up-sampling performance and low computational complexity utilizing singe stage or multi-stage data fusion to effectively incorporate the information of UL and DL CSI matrices, which can achieve improved performance for CSI up-sampling.

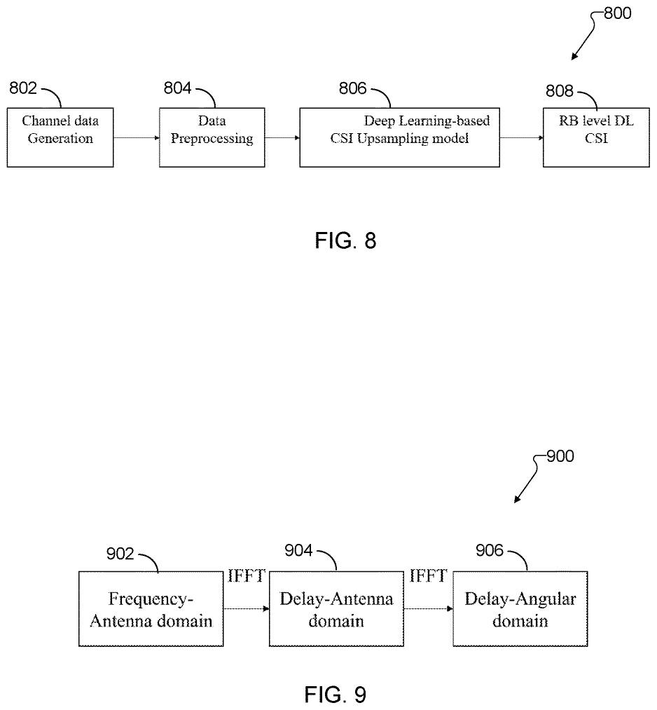

FIG. 8 illustrates an example flowchart of an example method 800 for deep learning-based CSI up-sampling according to one or more embodiments of the present disclosure. The embodiment of the method 800 shown in FIG. 8 is for illustration only. Other embodiments of the method 800 for deep learning-based CSI up-sampling could be used without departing from the scope of this disclosure.

The method 800 begins with the BS 102 generating the wireless channel data (referred to herein as the “channel data” or “CSI data”) which can be used for model training and testing, including the UL and DL CSI data (802). The generating of the CSI data refers to obtaining the channel response data for both UL and DL channels (UL CSI data and DL CSI data) including the DL CSI matrix H_{SB}, the RB-level UL CSI matrix H_{RB·UL}, and the RB-level DL CSI matrix H_{RB}. Here, not only the CSI data, but also extra information about the channel or received signals, e.g., signal to noise ratio (SNR) or transmission power, can also be estimated and stored. This can be done by channel simulation based on wireless channel models or the measurement carried out in the real field. This data can be used to train the deep learning-based CSI up-sampling model (the AI-based model).

Next, the CSI data (UL CSI data and DL CSI data) is preprocessed (804). The CSI data is preprocessed so that it has an improved structure and improves training of the deep learning-based CSI up-sampling model. The input of the deep learning-based CSI up-sampling model is the DL CSI matrix H_{SB} and UL CSI matrix H_{RB·UL}. The target data is the DL CSI matrix H_{RB}. By transforming the CSI data to other domains, such as the delay domain or the angular domain, the CSI data could become sparser. The sparsity of the CSI data can bring some benefits to the deep learning-based CSI up-sampling model. The benefits include, but are not limited to, the regularization effect, feature importance, and efficient storage and processing. With respect to the regularization effect, the sparse data acts as a natural form of regularization. When the available data is limited, models tend to generalize better because they focus on essential patterns rather than memorizing noise. With respect to feature importance, the sparse data highlights the importance of features. Rare but informative features receive more attention from the deep learning-based model. With respect to efficient storage and processing, sparse representations require less memory and computational resources, which is efficient for large-scale applications. Preprocessing the CSI data is described in more detail in the method 900 described in FIG. 9 below.

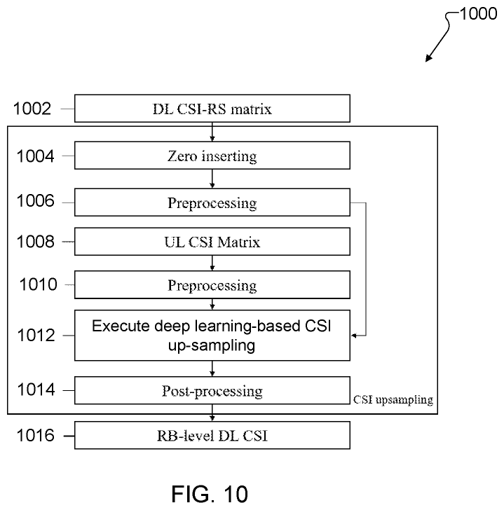

From there, a deep learning-based CSI up-sampling model is generated and trained with the preprocessed data (806). The deep learning-based CSI up-sampling model takes a noisy channel response as input and outputs an estimated channel response. This is described in more detail in the method 1000 of FIG. 10 below.

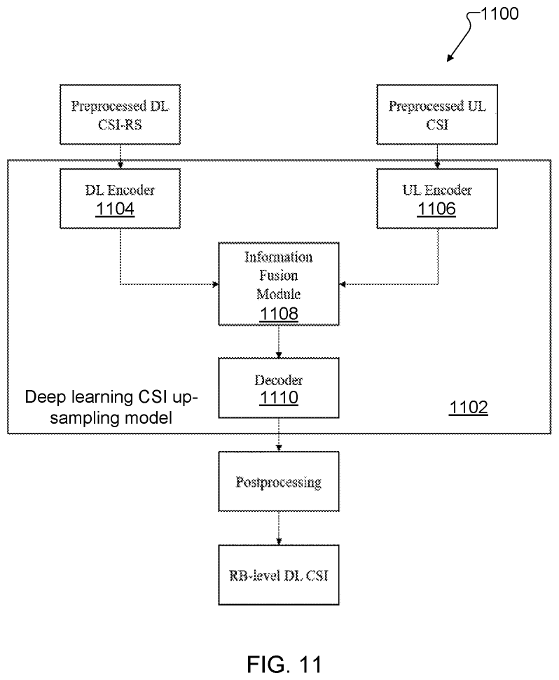

Then, the trained deep learning-based CSI up-sampling model is used to determine resource RB-level DL CSI information (808). The deep learning-based CSI up-sampling model is described in more detail in FIGS. 11-15 below.

FIG. 9 illustrates a flowchart of example method 900 for preprocessing CSI data according to embodiments of the present disclosure. Method 900 corresponds to operation 804 of the method 800. The embodiment of the method 900 shown in FIG. 9 is for illustration only. Other embodiments of the method 900 for preprocessing CSI data could be used without departing from the scope of this disclosure.

The method 900 begins with transforming the CSI data from the frequency-antenna domain to the delay-antenna domain using an inverse fast fourier transform (IFFT) (902-904). Next the CSI data is transformed from the delay-antenna domain to the delay-angular domain using a 2-dimensional FFT (2D FFT) based on the structure of the antenna (904-906). In one or more embodiments, based on the data preprocessing, the estimation result, i.e., the output of the efficient deep learning-based CSI up-sampling model, is converted back to frequency-antenna domain after it is output from the CSI up-sampling model.

FIG. 10 illustrates a flowchart of example method 1000 of CSI up-sampling using a deep learning-based CSI up-sampling model according to embodiments of the present disclosure. In one or more embodiments, the method 1000 is performed by the BS 102. The embodiment of the method 1000 shown in FIG. 10 is for illustration only. Other embodiments of the method 1000 for CSI up-sampling could be used without departing from the scope of this disclosure.

The method 1000 begins with the BS 102 receiving the SB-level DL CSI matrix (DL CSI data) from at least one UE (such as UE 116) and unsampling the SB-level DL CSI matrix by zero-inserting (1002-1004). Next, the SB-level DL CSI matrix is transformed into the delay-angular domain (preprocessing) for exploiting multi-party computation (MPC) between UL and DL CSIs (1006). Then, the BS 102 accesses the locally available UL CSI data (UL CSI matrix) by channel estimation (1008). The BS 102 then transforms (preprocesses) the UL CSI data into the delay-angular domain (1010). Then the BS 102 executes the deep learning-based CSI up-sampling model, such as a deep neural network, to estimate the RB-level DL CSI (RB-level DL CSI matrix) (1012). From there, the BS 102 transforms the resulting RB-level DL CSI back to the antenna-frequency domain (post-processing) (1014), resulting in the RB-level CSI information (data) (1016). As illustrated in the method 1000, operations 1008 and 1010 can be optional.

FIG. 11 illustrates an architecture 1100 including an example deep learning-based CSI up-sampling model 1102 according to embodiments of the present disclosure.

The architecture 1100 includes the deep learning-based CSI up-sampling model 1102 that includes a DL encoder 1104, an UL encoder 1106, an information fusion module 1108, and a decoder 1110. The DL encoder 1104 receives the preprocessed DL CSI data and the UL encoder 1106 receives the preprocessed UL CSI data described above. The DL encoder 1104 and the UL encoder 1106 are configured to generate encoded DL CSI data and encoded UL CSI data, respectively. The DL encoder 1104 and the UL encoder 1106 are configured to project the preprocessed DL CSI data and the preprocessed UL CSI data, respectively, to spaces (projected spaces) where the information from the preprocessed DL CSI data and the preprocessed UL CSI data can be easily fused by the information fusion module 1108. In these projection spaces, the deep learning-based CSI up-sampling model 1102 can extract hierarchical feature(s) from the preprocessed DL CSI data and the preprocessed UL CSI data. The information fusion module 1108 can be configured to fuse the projection spaces generated by the DL encoder 1104 and the UL encoder 1106. The projection spaces can be fused using any suitable method, including, but not limited to, multiplication of the DL CSI and UL CSI projection data (projection spaces), concatenating the DL and UL projection data, concatenating the original and the DL and UL CSI projection data, and attention mechanism (self-attention, cross-attention, channel attention, etc.), or the like. The information fusion module 1108 provides the fused DL CSI and UL CSI projection data (projection spaces) to the decoder 1110. The decoder 1110 is configured to refine the fused DL CSI and UL CSI projection data and project it back to the original space for the final post processing.

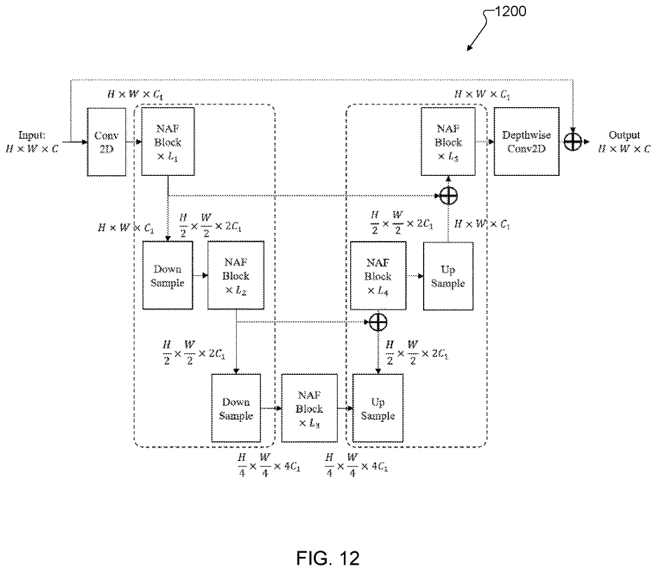

FIG. 12 illustrates an example encoder/decoder 1200 according to embodiments of the disclosure. The encoder/decoder 1200 can correspond to the DL encoder 1104, the UL encoder 1106, and/or the decoder 1110 of FIG. 11.

In one or more embodiments, the encoder/decoder 1200 can include a NAFNet (NAFNet block). Although the encoder/decoder 1200 is illustrated as a NAFNet, the encoder/decoder 1200 can include any suitable network structure. Furthermore, the DL encoder 1104, the UL encoder 1106, and/or the decoder 1110 can each have the same or different network structures.

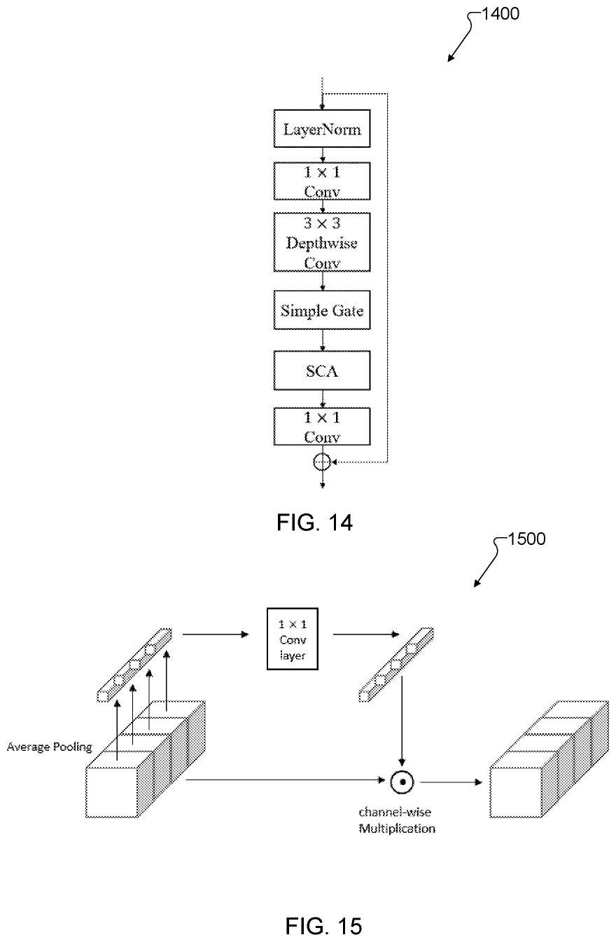

The network structure of the NAFNet block is illustrated in FIG. 14 below. In one or more embodiments, the hyperparameters for the deep learning-based CSI up-sampling model 1102, such as number of channels, number of NAFNet blocks at each in encoder, decoder, and bridge, given here obtained via fine-tuning experiments on the dataset. The hyperparameters can be tunable based on the amount of dataset, computation complexity requirement, memory requirement, and so on. The hyperparameters described above are for example purposes only, and should not be considered as restrictive to the (tunable) hyperparameters of the deep learning-based CSI up-sampling model 1102.

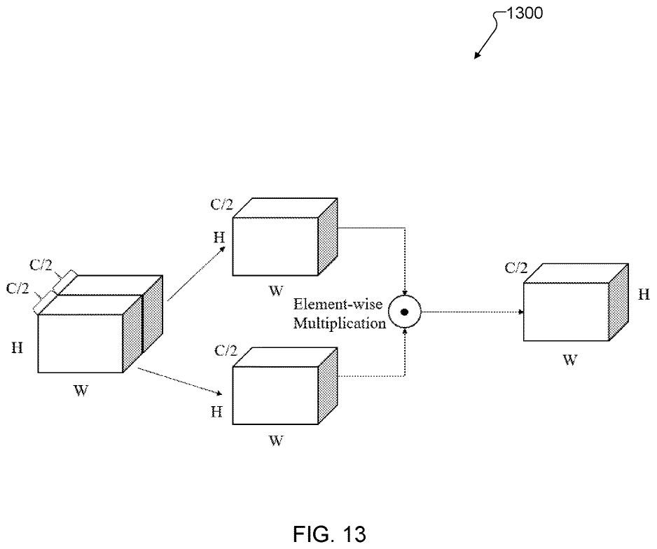

FIG. 13 illustrates an example simple gate 1300 used in a NAFNet block according to embodiments of the present disclosure. FIG. 14 illustrates an example NAFNet block 1400 according to embodiments of the present disclosure.

With NAFNet blocks as the basic building block (shown in FIG. 14), the NAFNet follows a U-Net-like hierarchical structure with an encoder-decoder framework, as shown in FIG. 11. The NAFNet block 1400 is the core of a NAFNet and includes two main components, the simple gate 1300 and simplified channel attention module(s) (shown in FIG. 15 below). The simple gate 1300 is a lightweight and efficient component to control the flow of information within the network. It is designed to replace activation functions (e.g. ReLU) and gating mechanisms (e.g. Gated Linear Units) with a simpler and more computationally efficient alternative. As shown in FIG. 13, the simple gate 1300 operates on an input feature X∈ [symbol] ^{H×W×C} Firstly, it evenly splits the input into two parts on the channel dimension, X=[X₁, X₂]. Here, X₁ ∈ [symbol] ^{H×W×C/2} and X₂∈ [symbol] ^{H×W×C/2} are the two halves of the input feature map. Then the simple gate 1300 applies a gating operation on X₁ using X₂ as a gate: Y=X₁*X₂, where Y is the output of the simple gate 1300 and * is an element-wise multiplication. The simple gate 1300 provides several benefits. Firstly, the simple gate 1300 eliminates the need for complex gating mechanisms or nonlinear activation functions, reducing the computation overhead. Secondly, the simple gate 1300 involves only splitting and element-wise multiplication, making it highly efficient in terms of both computation and memory usage. Despite its simplicity, the simple gate 1300 can effectively modulate feature maps improving the network's ability to capture and process important information.

As noted above, the other main component in the NAFNet block 1400 is a channel attention module. FIG. 15 illustrates an example channel attention module 1500 according to embodiments of the present disclosure.

In one or more embodiments, the channel attention module 1500 in the NAFNet block 1400 is referred to as a simplified channel attention (SCA). By retaining the two most important roles of channel attention, that is, aggregating global information and channel information, the SCA is computed as:

SCA(X)=X*WPool(X).

The attention weights SCA (X)∈ [symbol] ^{C} for each channel are obtained by input X∈ [symbol] ^{H×W×C} to an 2D average pooling and a 1×1 convolution layer. Compared with another channel attention module, the SCA eliminates the need for nonlinear activation functions and only uses one 1×1 convolutional layer, reducing computational cost and memory usage. By adaptively recalibrating channel-wise feature responses, the SCA helps the NAFNet (NAFNet block 1400) focus on important information, leading to better image restoration results. Despite its simplicity, the SCA effectively enhances feature representation and improves network performance.

Referring back to FIG. 14 the NAFNet block 1400 first applies a LayerNorm (LN) layer to the input feature. Then, an inverted residual block is used, which can include a 1×1 convolutional layer, a 3×3 depthwise convolutional layer, and a 1×1 convolutional layer. As noted above the inverted residual block can also include the simple gate1300 which can be used instead of nonlinear activation function (e.g. ReLU, GeLU). Furthermore, as noted above, the SCA (channel attenuation module 1500) is included in the NAFNet block 1400. Given an input feature X∈ [symbol] ^{H×W×C}, the first 1×1 convolutional layer will expand the channel number to 2C. The 3×3 depthwise convolutional layer is used to apply spatial filters to each channel independently, in order to reduce computational cost. Then the simple gate 1300 will project the feature map back to C channels. Then the SCA is used to help the network focus on important information. Then the 1×1 convolutional layer is the last component of the inverted residual block.

In one or more embodiments, the training of the efficient deep learning-based CSI up-sampling model 1102 can utilize the normalized channel gain (NCG) loss function which is the complex cosine similarity between channels h and true CSI f as given below:

$$NCG = \frac{\vert {h}^{H} f \vert}{‖ h ‖ ‖ f ‖}$$

The nominator|h^{H}f| represents the actual channel gain obtained from the precoder and the denominator aims to normalize the channel and the precoder.

In one or more embodiments, while having the information fusion of UL CSI data and DL CSI data occur only in the information fusion module 1108 can be simple and computationally efficient, however, there are drawbacks. For example, combining inputs at a single stage (the information fusion module 1108) may not allow for sufficient interaction between features from different inputs. This can lead to a less comprehensive understanding of the relationships between the inputs. A single fusion stage can create a bottleneck where crucial details from individual inputs are lost. This can result in a loss of important information that could have been preserved and utilized in a multi-stage fusion approach. One-stage fusion does not provide the flexibility to adjust the contribution of each input dynamically throughout the network. This can be problematic when different inputs have varying levels of importance at different stages of processing. Integrating information at only one stage can lead to shallow feature representations. Multi-stage fusion would allow for deeper and more hierarchical integration of feature(s), leading to richer and more informative representations. With only one fusion stage, the network might struggle to learn intermediate representations that are informative and discriminative. This can hinder the overall learning dynamics and convergence during training. Complex relationships between inputs may require multiple stages of fusion to be effectively captured. One-stage fusion might oversimplify these relationships, leading to suboptimal performance.

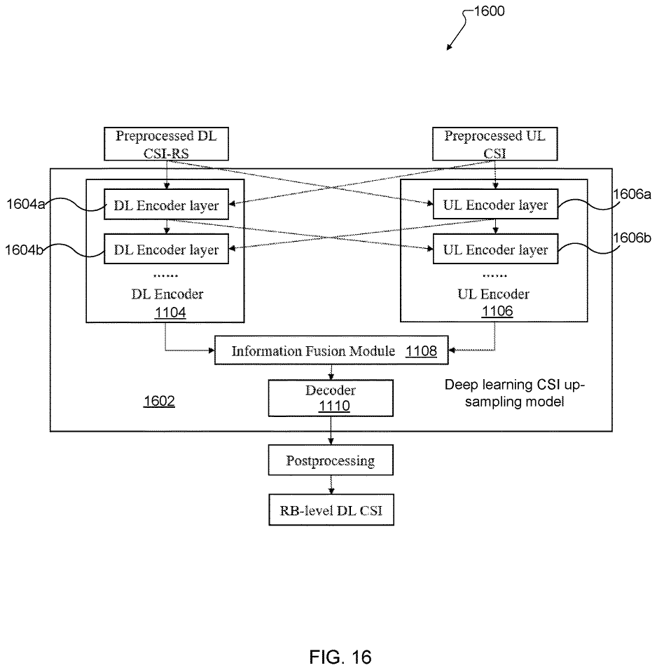

Therefore, in one or more embodiments, multi-stage information fusion can be used. FIG. 16 illustrates an example architecture 1600 including a deep learning-based CSI up-sampling model 1602 that utilizes multi-stage fusion according to embodiments or the present disclosure.

As illustrated in FIG. 16, the DL encoder 1104 can further include multiple DL encoder layers and the UL encoder 1106 can further include multiple UL encoder layers. For example, the DL encoder 1104 can include a first DL encoder layer 1604a (first encoder layer) and a second DL encoder layer 1604b (third encoder layer), and the UL encoder 1106 can include a first UL encoder layer 1606a (second encoder layer) and a second UL encoder layer 1606b (fourth encoder layer). Although the DL encoder 1104 and the UL encoder 1106 are described as including two respective decoder and encoder layers, this is for example purposes only. It is understood the DL encoder 1104 and the UL encoder 1106 can include any suitable quantiles of respective DL and UL encoder layers. In one or more embodiments, the quantity of DL and UL encoder layers can be the same or different.

Both the DL encoder layers and the UL encoder layers can accept both the DL CSI data and UL CSI data, allowing for multi-stage fusion of DL CSI data and UL CSI data. For example, as illustrated in FIG. 16, the first DL encoder layer 1604a and the first UL encoder layer 1606a receive both the preprocessed DL CSI data and UL CSI data to generate first encoded data and second encoded data, respectively. The first encoded data is provided to both the second DL encoder layer 1604b and the second UL encoder layer 1606b. The second encoded data is provided to both the second DL encoder layer 1604b and the second UL encoder layer 1606b. The second DL encoder layer 1604b generates third encoded data by encoding the first and second encoded data. The second UL encoder layer 1606b generates fourth encoded data by also encoding the first and second encoded data. This is continued until a last DL encoder layer and a last UL encoder layer receive data. For example, if the second DL and UL layers are the last layers, the third encoded data and the fourth encoded data are both provided to the information fusion module 1108.

Multiple fusion stages enable hierarchical processing of information, where early stages can focus on low-level features and later stages can integrate higher-level abstractions. Moreover, multiple fusion stages allow the network to progressively combine and refine features from different inputs. This can lead to more nuanced and comprehensive feature representations, improving the model's ability to capture complex relationships. In this structure the encoder layer can be and not limited to cross-attention module, self-attention module and NAF blocks, etc.

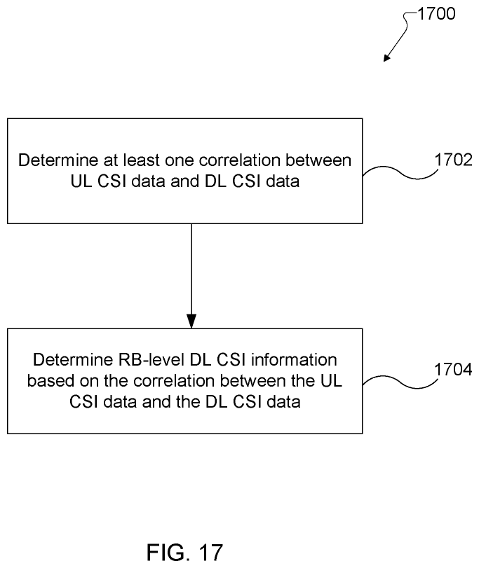

FIG. 17 illustrates a flowchart of example method 1700 for determining RB-level DL CSI information using a deep learning-based CSI up-sampling model according to embodiments of the present disclosure. In one or more embodiments, the method 1700 is performed by the BS 102. The embodiment of the method 1700 shown in FIG. 17 is for illustration only. Other embodiments of the method 1700 for determining RB-level DL CSI information could be used without departing from the scope of this disclosure.

The method 1700 begins with the BS 102 determining at least one correlation between an UL CSI data and DL CSI data using a deep learning-based CSI up-sampling model, such as deep learning-based CSI up-sampling model 1102 or deep learning-based CSI up-sampling model 1602 (1702). The at least one correlation can be determined in the same manner described in FIGS. 10-16. Next, also in the same manner described in FIGS. 10-16 above, the deep learning-based CSI up-sampling model determines RB-level DL CSI information based on the at least one correlation (1704).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for operating a base station (BS), the method comprising:
determining at least one correlation between an uplink (UL) channel state information (CSI) data and downlink (DL) CSI data using a deep learning-based CSI up-sampling model; and
determining resource block-level (RB-level) DL CSI information using the deep learning-based CSI up-sampling model based on the correlation between the UL CSI data and the DL CSI data.

2. The method of claim 1, further comprising:
generating the UL CSI data and the DL CSI data; and
preprocessing the UL CSI data and the DL CSI data, wherein the generating of the UL CSI data and the DL CSI data and the preprocessing the UL CSI data and the DL CSI data are performed prior to the determining of the at least one correlation between the UL CSI data and DL CSI data.

3. The method of claim 2, wherein generating the DL CSI data comprises:
receiving subband-level (SB-level) DL CSI data; and
unsampling the SB-level DL CSI data by zero-inserting.

4. The method of claim 2, wherein the UL CSI data is generated using channel estimation.

5. The method of claim 2, wherein the DL CSI data comprises an RB-level DL CSI matrix and the UL CSI data comprises an RB-level UL CSI matrix.

6. The method of claim 2, wherein preprocessing the UL CSI data and the DL CSI data comprises:
transforming the UL CSI data and DL CSI data from a frequency-antenna domain to a delay-antenna domain; and
transforming the UL CSI data and DL CSI data from the delay-antenna domain to a delay-angular domain.

7. The method of claim 2, wherein the determining the RB-level DL CSI information comprises:
encoding the preprocessed DL CSI data using a DL encoder to generate encoded DL CSI data; and
encoding the preprocessed UL CSI data using a UL encoder to generate encoded UL CSI data, wherein the UL encoder and the DL encoder each comprise a Nonlinear Activation Free Network (NAFNet).

8. The method of claim 7, wherein the determining the RB-level DL CSI information further comprises:
receiving, by an information fusion module, the encoded DL CSI data from the DL encoder and the encoded UL CSI data from the UL encoder; and
fusing, by the information fusion module, the encoded DL CSI data and the encoded UL CSI data into fused data.

9. The method of claim 8, further comprising decoding the fused data using a decoder comprising a Nonlinear Activation Free Network (NAFNet).

10. The method of claim 2, wherein the determining the RB-level DL CSI information comprises:
encoding the preprocessed DL CSI data and the UL CSI data using a first encoder layer to generate first encoded data;
encoding the preprocessed DL CSI data and the UL CSI data using a second encoder layer to generate second encoded data;
encoding the first encoded data and the second encoded data using a third encoder layer to generate third encoded data; and
encoding the first encoded data and the second encoded data using a fourth encoder layer to generate fourth encoded data.

11. A base station (BS) comprising:
at least one processor including processing circuitry; and
a memory storing instructions, wherein the instructions, when executed by the at least one processor, individually or collectively, cause the BS to:
determine at least one correlation between an uplink (UL) channel state information (CSI) data and downlink (DL) CSI data using a deep learning-based CSI up-sampling model; and
determine resource block-level (RB-level) DL CSI information using the deep learning-based CSI up-sampling model based on the correlation between the UL CSI data and the DL CSI data.

12. The BS of claim 11, wherein the instructions further comprise instructions to:
generate the UL CSI data and the DL CSI data; and
preprocess the UL CSI data and the DL CSI data, wherein the generating of the UL CSI data and the DL CSI data and the preprocessing the UL CSI data and the DL CSI data are performed prior to the determining of the at least one correlation between the UL CSI data and DL CSI data.

13. The BS of claim 12, wherein the generating of the DL CSI data comprises:
receiving subband-level (SB-level) DL CSI data; and
unsampling the SB-level DL CSI data by zero-inserting.

14. The BS of claim 12, wherein the UL CSI data is generated using channel estimation.

15. The BS of claim 12, wherein the DL CSI data comprises an RB-level DL CSI matrix and the UL CSI data comprises an RB-level UL CSI matrix.

16. The BS of claim 12, wherein the preprocessing of the UL CSI data and the DL CSI data comprises:
transforming the UL CSI data and DL CSI data from a frequency-antenna domain to a delay-antenna domain; and
transforming the UL CSI data and DL CSI data from the delay-antenna domain to a delay-angular domain.

17. The BS of claim 12, wherein the determining of the RB-level DL CSI information comprises:
encoding the preprocessed DL CSI data using a DL encoder to generate encoded DL CSI data; and
encoding the preprocessed UL CSI data using a UL encoder to generate encoded UL CSI data, wherein the UL encoder and the DL encoder each comprise a Nonlinear Activation Free Network (NAFNet).

18. The BS of claim 17, wherein the determining of the RB-level DL CSI information further comprises:
receiving, by an information fusion module, the encoded DL CSI data from the DL encoder and the encoded UL CSI data from the UL encoder; and
fusing, by the information fusion module, the encoded DL CSI data and the encoded UL CSI data into fused data.

19. The BS of claim 18, wherein the instructions further comprise instructions to decode the fused data using a decoder comprising a Nonlinear Activation Free Network (NAFNet).

20. The BS of claim 12, wherein the determining of the RB-level DL CSI information comprises:
encoding the preprocessed DL CSI data and the UL CSI data using a first encoder layer to generate first encoded data;
encoding the preprocessed DL CSI data and the UL CSI data using a second encoder layer to generate second encoded data;
encoding the first encoded data and the second encoded data using a third encoder layer to generate third encoded data; and
encoding the first encoded data and the second encoded data using a fourth encoder layer to generate fourth encoded data.
